(19) United States
(12) Patent Application Publication
(10) Pub. No.: US 2015/0376555 A1
(43) Pub. Date: Dec. 31, 2015

(54) LAUNDRY DETERGENT COMPOSITIONS

(71) Applicant: The Procter & Gamble Company, Cincinnati, OH (US)

(72) Inventor: Gregory Scot MIRACLE, Liberty Township, OH (US)

(21) Appl. No.: 14/710,662

(22) Filed: May 13, 2015

Related U.S. Application Data
(60) Provisional application No. 62/018,007, filed on Jun. 27, 2014.

(51) Int. Cl. C11D 3/42; C11D 3/34; C11D 1/83; C11D 11/00

(52) U.S. Cl. CPC C11D 3/42; C11D 11/0017; C11D 3/349; C11D 1/83

(57) ABSTRACT

A laundry detergent is provided that effectively cleans and whitens textile substrates, but also provides decreased staining of the substrate when used during the laundering process.

### FIELD OF THE INVENTION

The present invention relates to laundry detergents and more particularly to liquid laundry detergents that provide effective cleaning and whitening of textile substrates, but also provide decreased staining of the substrate when used during the laundering process.

### BACKGROUND OF THE INVENTION

As textile substrates age, their color tends to fade or yellow due to exposure to light, air, soil, and natural degradation of the fibers that comprise the substrates. Thus, the purpose of shading dyes is generally to visually whiten these textile substrates and counteract the fading and yellowing of the substrates. Typically, shading dyes may be found in laundry detergents and are therefore applied to textile substrates during the laundering process. However, it is important that shading dyes function to whiten treated textile substrates without causing undesirable staining of the textile substrates.

Laundry detergents are also formulated to contain one or more surfactants to remove soils and generally clean the laundered substrate. However, it has been found that certain surfactants increase the staining or graying of textile substrates and, in particular, polyester.

As a result, there exists a need for laundry detergents with shading dyes which are capable of eliminating the yellowness exhibited by ageing textile substrates, but also provide optimal cleaning and decreased staining or graying of the substrate.

It has surprisingly been found that the compositions of the present invention are not only effective in cleaning and whitening of textile substrates, but also provide decreased staining of the substrate when used during the laundering process.

### SUMMARY OF THE INVENTION

In one aspect the present invention provides laundry detergent compositions comprising:
(i) from 0.0001 to 0.01 wt % of a shading dye; and
(ii) (ii) from 5 to 70 wt % of surfactants selected from anionic and non-ionic surfactants,
wherein the weight fraction of non-ionic surfactant is from 0.05 to 0.75 of the total wt % of the anionic and non-ionic surfactants,
wherein the non-ionic surfactant comprises from greater than 50 to 100 wt % of an alkyl ethoxylate with a C12 to C15 primary alkyl chain and 6 or less ethoxy groups.

In one embodiment, the dye is of the form:

Dye-NR¹R²,

wherein the NR¹R²group is attached to an aromatic ring of the dye and R1 and R2 are independently selected from H, C₁₋8 alkyl, C6-10 aryl, C7-16 alkyl and a polyoxyalkylene chain having 2 or more repeating units, optionally comprising an anionic group. It may be preferred to have at least one of R1 and R2 being a polyoxyalkylene chain having 2 or more repeating units and comprising an anionic group, which optionally terminates the chain. Preferably the anionic group is selected from CO₂⁻ and, SO₃⁻.

In another aspect the present invention provides laundry liquid detergent composition comprising:
(i) from 0.0001 to 0.01 wt % %, preferably 0.0003 to 0.005 wt %, more preferably from 0.0005 to 0.003 wt %, of a shading dye comprising an anionic group covalently bound to alkoxy groups; and,
(ii) (ii) from 5 to 70 wt % of surfactants selected from anionic and non-ionic surfactants,
wherein the weight fraction of non-ionic surfactant is from 0.05 to 0.75, preferably from 0.1 to 0.6, more preferably from 0.3 to 0.6, most preferably from 0.35 to 0.55, of the total wt % of the anionic and non-ionic surfactants, wherein the non-ionic surfactant comprises from 0.5 to 49.5 wt %, preferably 10 to 45 wt %, most preferably 25 to 40wt % of an alkyl ethoxylate with a C12 to C15 primary alkyl chain and 7 to 9 ethoxy groups, and
   wherein the dye is of the form:

Dye-NR¹R²,

wherein the NR¹R² group is attached to an aromatic ring of the dye and at least one of the R¹ and R² groups is independently selected from: a polyoxyalkylene chain having 2 or more repeating units and is terminated by an anionic group, wherein the dye is a mono-azo dye and the anionic group is selected from: CO₂⁻ and, SO₃⁻.

In another aspect the present invention provides laundry liquid detergent composition comprising:
(i) from 0.0001 to 0.01 wt % of a shading dye comprising an anionic group covalently bound to alkoxy groups; and,
(ii) from 5 to 70 wt % of surfactants selected from anionic and non-ionic surfactants,
   wherein the weight fraction of non-ionic surfactant is from 0.05 to 0.75 of the total wt % of the anionic and non-ionic surfactants,
   wherein the non-ionic surfactant comprises from greater than 50 to 100 wt % of an alkyl ethoxylate with a C12 to C15 primary alkyl chain and an average ethoxy group selected from the group consisting of 1, 2, 3, 4, 5, 6 and mixtures thereof, and

wherein the dye is of the form:

Dye-NR¹R²,

wherein the NR¹R²group is attached to an aromatic ring of the dye and at least one of the R¹ and R² groups is independently selected from: a polyoxyalkylene chain having 2 or more repeating units and is terminated by an anionic group, wherein the dye is a mono-azo dye and the anionic group is selected from: CO₂⁻ and, SO₃⁻.

In another aspect the present invention provides laundry liquid detergent composition comprising:
(iii) from 0.0001 to 0.01 wt %%, preferably 0.0003 to 0.005 wt %, more preferably from 0.0005 to 0.003 wt %, of a shading dye comprising an anionic group covalently bound to alkoxy groups; and,
(iv) (ii) from 5 to 70 wt % of surfactants selected from anionic and non-ionic surfactants,
   wherein the weight fraction of non-ionic surfactant is from 0.05 to 0.75, preferably from 0.1 to 0.6, more preferably from 0.3 to 0.6, most preferably from 0.35 to 0.55, of the total wt % of the anionic and non-ionic surfactants, wherein the non-ionic surfactant comprises from 0.5 to 49.5 wt %, preferably 10 to 45 wt %, most preferably 25 to 40wt % of an alkyl ethoxylate with a C12 to C15 primary alkyl chain and an average ethoxy group selected from the group consisting of 7, 8, 9 and mixtures thereof, and
   wherein the dye is of the form:

Dye-NR¹R²,

wherein the NR¹R² group is attached to an aromatic ring of the dye and at least one of the R¹ and R^{e}groups is independently selected from: a polyoxyalkylene chain having 2 or more repeating units and is terminated by an anionic group, wherein the dye is a mono-azo dye and the anionic group is selected from: CO₂⁻ and, SO₃⁻.

### DETAILED DESCRIPTION OF THE INVENTION

### Surfactant

The composition comprises between 5 to 70 wt % of surfactants selected from anionic and non-ionic surfactants, most preferably 10 to 30 wt %. The fraction of non-ionic surfactant is from 0.05 to 0.75 of the total wt % of the anionic and non-ionic surfactant, preferably from 0.1 to 0.6, more preferably from 0.3 to 0.6, most preferably from 0.35 to 0.55. In general, the nonionic and anionic surfactants of the surfactant system may be chosen from the surfactants described “Surface Active Agents” Vol. 1, by
Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981. Preferably the surfactants used are saturated.

### Non-Ionic Surfactants

Suitable nonionic surfactants which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Preferred nonionic surfactants are C₆ to C₂₂ alkyl phenol-ethylene oxide condensates, with 1 to 9 EO, i.e. 1 to 9 units of ethylene oxide per molecule, and the condensation products of aliphatic C₈ to C₁₈ primary or secondary linear or branched alcohols with ethylene oxide, with 1 to 9 EO. In one particularly preferred embodiment, the nonionic surfactants are C₆ to C₂₂ alkyl phenol-ethylene oxide condensates, with 6 or less EO, i.e. 6 or less units of ethylene oxide per molecule, and the condensation products of aliphatic C₈ to C₁₈ primary or secondary linear or branched alcohols with ethylene oxide, with 6 or less EO.

The non-ionic surfactant preferably contains an alkyl alkoxylate. The alkyl alkoxylate is preferably an alkyl ethoxylate, with formula R¹(OCH₂CH₂)pOH: where R₁ is an alkyl group that may be primary or secondary and contains C10-C16 carbon atoms. Most preferably R₁ is a C12-C15 primary alkyl chain, p is from 1 to 9, preferably 6 or less. Preferably, the non-ionic surfactant comprises from greater than 50 to 100 wt % of an alkyl ethoxylate with a C12 to C15 primary alkyl chain and 6 or less ethoxy groups.

Preferably, the non-ionic surfactant comprises from 0.5 to 49.5 wt %, preferably 10 to 45 wt %, most preferably 25 to 40wt % of an alkyl ethoxylate with a C12 to C15 primary alkyl chain and 7 to 9 ethoxy groups. In another embodiment, the non-ionic surfactant preferably comprises from 0.5 to 49.5 wt %, preferably 10 to 45 wt %, most preferably 25 to 40wt % of an alkyl ethoxylate with a C12 to C15 primary alkyl chain and an average ethoxy group selected from the group consisting of 7, 8, 9 and mixtures thereof. It will be understood that in this embodiment the average ethoxy group of 7, 8 and/or 9 can be the average of any mixture of ethoxy chain lengths, including in some embodiments with non-integer ethoxy chain lengths, as known in the art. For example, it will be understood in this embodiment that an average ethoxy group of 8 may result from a mixture of an ethoxy group of about 6 and an ethoxy group of about 10.

### Anionic Surfactants

Suitable anionic detergent compounds which may be used are usually water soluble alkali metal salts of organic sulphates and sulphonates having alkyl radicals containing from about 8 to about 22 carbon atoms, the term alkyl being used to include the alkyl portion of higher acyl radicals. Examples of suitable synthetic anionic detergent compounds are sodium and potassium alkyl sulphates, especially those obtained by sulphating higher C₈ to C₁₈ alcohols, produced for example from tallow or coconut oil, sodium and potassium alkyl C₈ to C₂₀ benzene sulphonates, particularly sodium linear secondary alkyl C₁₀ to C₁₅ benzene sulphonates; and sodium alkyl glyceryl ether sulphates, especially those ethers of the higher alcohols derived from tallow or coconut oil and synthetic alcohols derived from petroleum. Most preferred anionic surfactants are sodium lauryl ether sulfate (SLES), particularly preferred with 1 to 3 ethoxy groups, sodium C₁₀ to C₁₅ alkyl benzene sulphonates and sodium C₁₂ to C₁₅ alkyl sulphates. The chains of the surfactants may be branched or linear.

Soaps are also preferred. The fatty acid soap used preferably contains from about 12 to about 22 carbon atoms, preferably in a straight chain configuration. The anionic contribution from soap is preferably from 0 to 30 wt % of the total anionic.

Preferably, at least 50 wt % of the anionic surfactant are selected from: sodium C₁₁ to C₁₅ alkyl benzene sulphonates; and, sodium C₁₂ to C₁₅ alkyl sulphates. Even more preferably, the anionic surfactant is sodium C₁₁ to C₁₅ alkyl benzene sulphonates.

The anionic surfactant is not a zwitterionic surfactant.

### Dye

The anionic alkoxylated dye is preferably blue or violet. The dye has a molar extinction coefficient at a wavelength in the range 400 to 700 nm of at least 10 000 L mol¹ L cm¹, preferably greater than 30000 L mol¹ L cm¹.

The fabric shading dye is preferably selected from azo dyes such as mono or bis azo dyes, anthraquinone dyes, triarylmethane and azine dyes. Azo dyes may be preferred. Azine dyes may be preferred. Examples of suitable dyes may be found in EP1794276A, EP1794275A, EP1633842A and EP1761623A.

The anionic alkoxylated dyes are preferably of the following generic form: Dye-NR₁R₂. The NR¹R² group is attached to an aromatic ring of the dye. Where at least one of R₁ and R₂ are independently selected from polyoxyalkylene chains having 2 or more repeating units and preferably having 2 to 15 repeating units, wherein the polyalkylene chain is terminated by an anionic group. Examples of polyoxyalkylene chains include ethylene oxide, propylene oxide, glycidol oxide, butylene oxide and mixtures thereof. The anionic alkoxylated dye is preferably a mono-azo dye.

Preferably the dye is of the form:

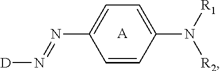

wherein D is an aromatic or hetroaromatic group and the A group may be substituted by further charged or uncharged organic groups. D is preferably a phenyl or a thiophene. Examples of uncharged organic groups are methyl, ethyl, NHCOCH₃, methoxy, ethoxy. An example of a charged organic group is NHC(O)CH₂CH(CO₂Na)CH₂CH═CH(CH₂)₄CH₃.

Preferably the anionic group is CO₂⁻ and SO₃⁻, most preferably SO₃⁻ (sulphonate). The anionic group of the dye may be part of a zwitterionic moiety however this is not preferred. An example of a zwitterionic group is:

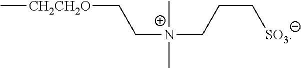

Preferably the polyoxyalkylene chain is a polyethoxylate with 2 to 15 ethoxylates or preferably 2 to 7 ethoxylates.

Preferably the mono-azo dye is a thiophene dye.

Preferably the only charged species on the dye is the SO₃⁻ group.

Examples of dye are:

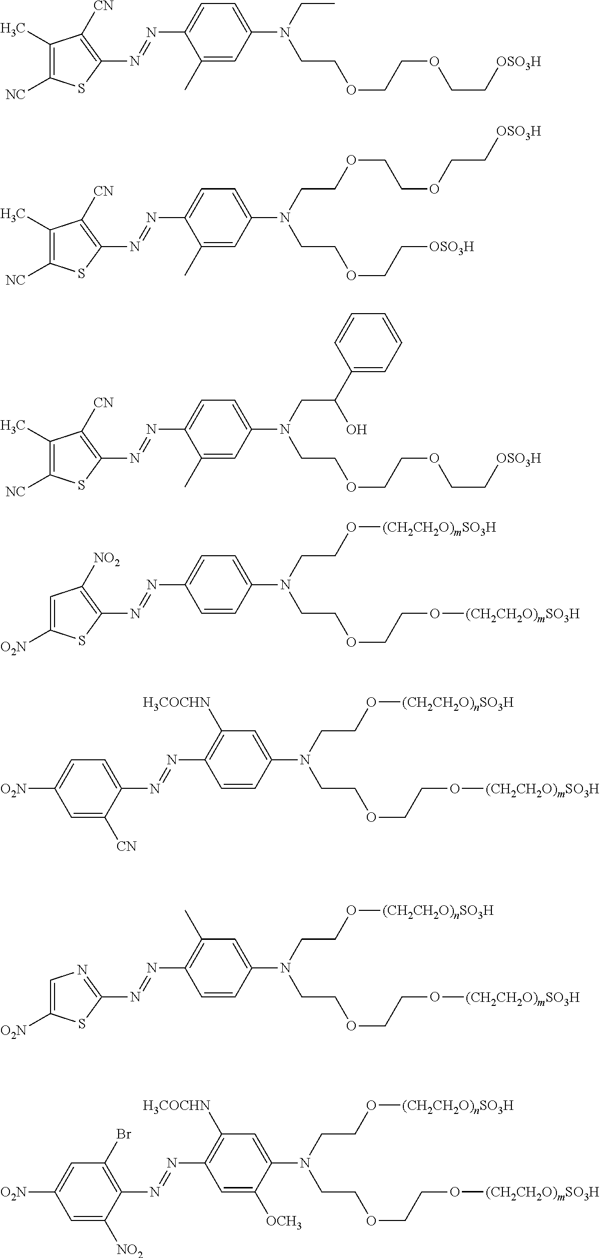

where n is from 0, 1, 2, 3, 4, 5, 6 or 7 and where m is from 0, 1, 2, 3, 4, 5, 6 or 7.

Most preferably the dye is of the form: where n is from 0, 1, 2, 3, 4, 5, 6 or 7 and where m is from 0, 1, 2, 3, 4, 5, 6 or 7.

To prevent fading of the liquid on storage the liquid is preferably stored in a colored plastic bottle, for example an orange, red or blue bottle.

The pH of the liquid detergent composition is preferably from 7 to 9. Preferably the liquid detergent composition comprises water, i.e., is aqueous and preferably the composition comprises from 5 wt % to 80 wt % water, most preferably from 10 to 80 wt % water. Preferably the pH of the aqueous liquid detergent composition is from 7 to 9.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A laundry detergent composition comprising:
(i) from 0.0001 to 0.01 wt % of a shading dye; and,
(ii) from 5 to 70 wt % of surfactants selected from anionic and non-ionic surfactants,
wherein the weight fraction of non-ionic surfactant is from 0.05 to 0.75 of the total wt % of the anionic and non-ionic surfactants,
wherein the non-ionic surfactant comprises from greater than 50 to 100 wt % of an alkyl ethoxylate with a C12 to C15 primary alkyl chain and 6 or less ethoxy groups.

2. A detergent composition according to claim 1 in which the dye is selected from azo dyes, anthraquinone dyes, triarylmethane dyes and azine dyes.

3. A detergent composition according to claim 1, wherein the dye is of the form:
Dye-NR¹R²,
wherein the NR¹R²group is attached to an aromatic ring of the dye and R¹ and R² are independently selected from H, C₁₋₈ alkyl, C₆₋₁₀ aryl, C₇₋₁₆ alkaryl and a polyoxyalkylene chain having 2 or more repeating units, optionally comprising an anionic group.

4. A detergent composition according to claim 3 wherein at least one of R¹ and R² comprises a polyoxyalkylene chain having 2 or more repeating units and comprising an anionic group, which optionally terminates the chain, the anionic group being selected from CO₂⁻ and, SO₃⁻.

5. A detergent composition according to claim 1, wherein non-ionic surfactant comprises from 70 to 100 wt % of the alkyl ethoxylate with the C12 to C15 primary alkyl chain and less than 6 ethoxy groups.

6. A detergent composition according to claim 5, wherein non-ionic surfactant comprises from 90 to 100 wt % of the alkyl ethoxylate with the C12 to C15 primary alkyl chain and less than 6 ethoxy groups.

7. A detergent composition according to claim 3, wherein both R¹ and R² are the polyoxyalkylene chains.

8. A detergent composition according to claim 7, wherein the polyoxyalkylene chain of the dye has from 2 to 15 repeating units.

9. A detergent composition according to claim 1, wherein the dye is of the form: 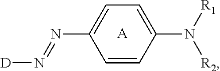
wherein D is an aromatic or hetroaromatic group.

10. A detergent composition according to claim 9, wherein the dye is an azo-thiophene.

11. A detergent composition according to claim 1, wherein the shading dye is present from 0.0003 to 0.003 wt % of the composition.

12. A detergent composition according to claim 1, wherein the weight fraction of non-ionic surfactant is from 0.3 to 0.6 of the total wt % of the anionic and non-ionic surfactants.

13. A detergent composition according to claim 1, wherein the pH of the liquid detergent composition is preferably from 7 to 9.

14. A laundry detergent composition comprising:
(i) from 0.0001 to 0.01 wt % of a shading dye comprising an anionic group covalently bound to alkoxy groups; and,
(ii) from 5 to 70 wt % of surfactants selected from anionic and non-ionic surfactants,
wherein the weight fraction of non-ionic surfactant is from 0.05 to 0.75 of the total wt % of the anionic and non-ionic surfactants,
wherein the non-ionic surfactant comprises from 0.5 to 49.5 wt % of an alkyl ethoxylate with a C12 to C15 primary alkyl chain and 7 to 9 ethoxy groups, and
wherein the dye is of the form:
Dye-NR¹R²,
wherein the NR¹R²group is attached to an aromatic ring of the dye and at least one of the R¹ and R² groups is independently selected from: a polyoxyalkylene chain having 2 or more repeating units and is terminated by an anionic group, wherein the dye is a mono-azo dye and the anionic group is selected from: CO₂⁻ and, SO₃⁻.

15. A detergent composition according to claim 14, wherein non-ionic surfactant comprises from 10 to 45 wt % of the alkyl ethoxylate with the C12 to C15 primary alkyl chain and 7 to 9 ethoxy groups.

16. A detergent composition according to claim 15, wherein non-ionic surfactant comprises from 25 to 40 wt % of the alkyl ethoxylate with the C12 to C15 primary alkyl chain and 7 to 9 ethoxy groups.

17. A detergent composition according to claim 14, wherein both R¹ and R² are the polyoxyalkylene chains.

18. A detergent composition according to claim 14, wherein the polyoxyalkylene chain of the dye has from 2 to 15 repeating units.

19. A liquid detergent composition according to claim 14, wherein the dye is of the form: 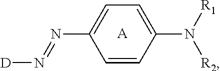
wherein D is an aromatic or hetroaromatic group.

20. A detergent composition according to claim 14, wherein the dye is an azo-thiophene.
